(19) United States
(12) Patent Application Publication
(10) Pub. No.: US 2013/0014401 A1
(43) Pub. Date: Jan. 17, 2013

(54) Clothes Water Squeezer

(71) Applicant: Marlene Matias, Bronx, NY (US)

(72) Inventor: Marlene Matias, Bronx, NY (US)

(21) Appl. No.: 13/549,345

(22) Filed: Jul. 13, 2012

Related U.S. Application Data
(60) Provisional application No. 61/572,377, filed on Jul. 13, 2011.

(51) Int. Cl. F26B 11/02

(52) U.S. Cl. 34/58

(57) ABSTRACT

A portable clothes drying device to remove excess water from hand washed clothes, comprising a cylindrical tub shaped outer vessel and having a rotatable inner basket, wherein the inner basket comprises small holes for the egress of water therethrough upon rotation; further comprising suction cups placed on the bottom of the device to secure the device to surface during use; further comprising a top lid attached to the vessel by a hinge and secured to the vessel by means of one or more securing clips on the edge of the outer vessel to clip the edge of the lid; further comprising an switch for turning the unit on and off; further comprising a motor for rotating the inner basket; further comprising a drain spout near the base of the outer vessel for allowing water to drain from the device.

### CLAIM OF PRIORITY

This patent application claims priority under 35 USC 119 (e) (1) from U.S. Provisional Patent Application Ser. No. 61/572,377 filed Dec. 10, 2009, of common inventorship herewith entitled, “CLOTHES WATER SQUEEZER.”

### FIELD OF THE INVENTION

The present invention pertains to the field of electrical appliances, and more specifically to the field of portable clothes wringing electrical appliances.

### BACKGROUND OF THE INVENTION

The prior art has put forth several designs for portable clothes wringing electrical appliances. Among these are:

U.S. Pat. No. 4,928,505 to Lee R. Parks and Wiley A. Kittrell describes a wringer appliance for squeezing liquid from a wet cloth. This wringer comprises housing with first and second rollers, the first roller with an electrical motor disposed therein for providing rotational power to the second roller.

U.S. Pat. No. 3,377,872 to Anthony E. Hodson and Richard P. G. Collinson describes a rate gyroscope system monitored for precession and speed and direction of rotation. A closed servo control loop monitors the gimbal damping for undue friction, and magnets set in the surface of the rotor cooperate with a magnetic pickoff to indicate the direction of rotor rotation.

U.S. Pat. No. 2,677,951 to John F. Haines and Betty F. Haines describes a portable wringer, adapted for temporary mounting on a wash basin or sink, to be used for wringing clothing and other articles washed by hand. The wringer described in this invention is lightweight, made of suitable plastic material, so that it can be transported and stored easily.

None of these prior art references describe the present invention.

### SUMMARY OF THE INVENTION

It is an object of the present invention to provide an improved portable clothes wringing electrical appliance for small spaces.

### BRIEF DESCRIPTION OF THE DRAWINGS

FIG. 1 is a perspective view showing the present invention with a lid lifted from an opening, a water outlet, and an electrical cord and plug.

FIG. 2 is a perspective view showing the present invention with a lid closed on an opening with edges to secure and lock the lid, and on and off switch, and an electrical cord plug.

FIG. 3 is a bottom perspective view of the present invention showing suction cups for gripping a surface on which it resides.

FIG. 4 is a perspective view of the spinner basket located within the present invention, showing small holes to release water and a small motor to power the spinner basket.

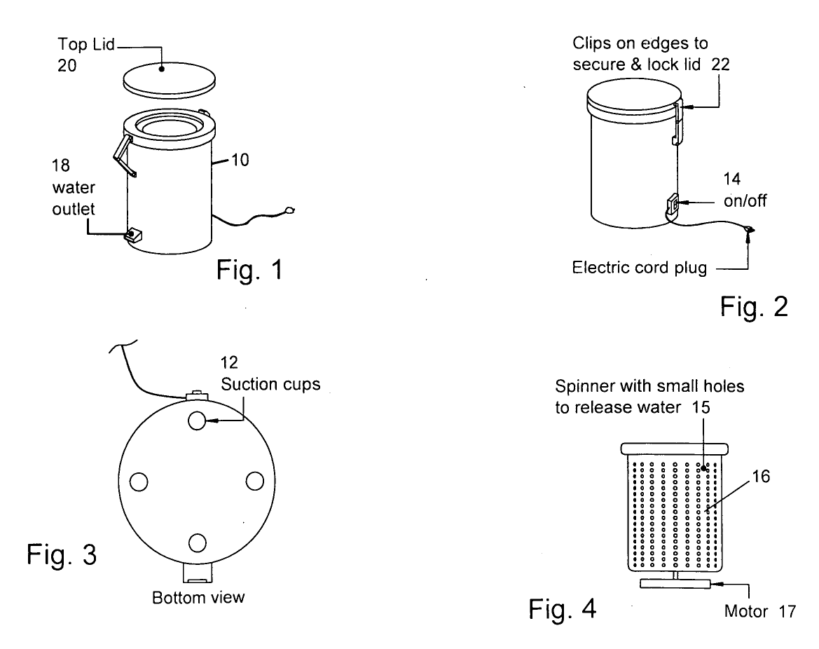

### DETAILED DESCRIPTION OF THE INVENTION

Cleaning dirty laundry became necessary household chore ever since man first donned body covering material. In earlier times, washing clothes involved dunking cloth items in a local stream, beating them against a nearby flat rock and wringing them out by hand to dry. Having a pile of dirty laundry to wash is an unavoidable task in active households. Modern washing machines have taken the physical work out of clothes washing, but some clothing items are too delicate to be put through modern washers and dryers. These delicate items, such as undergarments and sweaters, are hand washed and air dried. Even men's neckties are washed by hand. Hand washed garments must be squeezed or wrung by hand to remove excess water. This hand wringing process quickly leads to sore hands and is very difficult for sufferers of hand ailments such as arthritis and carpal tunnel syndrome.

The present invention, hereinafter referred to as the Clothes Water Squeezer, is a compact electrically operated device designed to squeeze excess water from clothing washed by hand. Comprised of a sturdy aluminum cylindrical vessel 10 with a white finish, the Clothes Water Squeezer is a small cylindrical tub shaped unit intended to be placed next to a bathroom sink or inside a bathtub. To facilitate holding the unit to the counter or bathtub surfaces, the bottom of the unit contains a series of suction cups 12 that adhere to the chosen surface. The top lid 20 is secured to the vessel by means of securing clips 22 on the edges of the vessel to secure and lock the lid while the unit is in use.

The Clothes Water Squeezer includes a conveniently located On and Off switch 14. Internally, the present invention works by rotating the inner basket 16 containing the clothing until the excess water is removed. The inner basket spins when the unit is turned on and centrifugal force forces the water out of the clothes and the water exits through small holes 15 for discharge though the water outlet 18 and drain into and adjacent sink or tub. A small motor 17 for powering the Clothes Water Squeezer is encased in the bottom portion of the unit. A water drain spout 18 on the outside base of the present invention provides a means for excess water to exit and drain into an adjacent sink or tub. Conveniently sized to fit beside a bathroom sink or inside a bathtub, this small appliance requires little space to operate. The incorporation of a handy drying element allows the garments to emerge from the unit drip free. The compact size of this product renders it ideal for use in hotel rooms and other public accommodations, making a very useful travel appliance. The cost-effective implementation of the Clothes Water Squeezer saves consumers money by ending expensive forays to dry cleaning establishments when needing to wash more delicate clothing.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable clothes drying device to remove excess water from hand washed clothes, comprising a cylindrical tub shaped outer vessel and having a rotatable inner basket, wherein the inner basket comprises small holes for the egress of water therethrough upon rotation; further comprising suction cups placed on the bottom of the device to secure the device to surface during use; further comprising a top lid attached to the vessel by a hinge and secured to the vessel by means of one or more securing clips on the edge of the outer vessel to clip the edge of the lid; further comprising a switch for turning the unit on and off; further comprising a motor for rotating the inner basket; further comprising a drain spout near the base of the outer vessel for allowing water to drain from the device.

2. The portable clothes drying device of claim 1, designed to be placed on a counter top or in a bathtub, and wherein the outer vessel is comprised of aluminum.

3. The portable clothes drying device of claim 1 comprising two securing clips on the edge of the outer vessel to secure the lid to the outer vessel.

4. The portable clothes drying device of claim 1 comprising four suction cups on the bottom of the vessel.
